(19) United States
(12) Patent Application Publication
(10) Pub. No.: US 2018/0257853 A1
(43) Pub. Date: Sep. 13, 2018

(54) PAPER-MADE COFFEE DRIPPER FOR USE IN DRIP-BREWING COFFEE

(71) Applicant: Tsung-Tse CHUANG, Nanton County (TW)

(72) Inventor: Tsung-Tse CHUANG, Nanton County (TW)

(21) Appl. No.: 15/453,011

(22) Filed: Mar. 8, 2017

(51) Int. Cl. B65D 85/804; A47J 31/06; B65D 3/02; B65D 3/28; B65D 3/10; B65D 17/00

(52) U.S. Cl. CPC B65D 85/8043; A47J 31/06; B65D 17/161; B65D 3/28; B65D 3/10; B65D 3/02

(57) ABSTRACT

A paper-made coffee dripper is formed by folding a single sheet of heat-resistant paper model for use in drip-brewing coffee; and includes a ground coffee bag connected to and suspended in a U-shaped stand formed by sequentially connected front, rear and bottom walls. The ground coffee bag includes at least one smaller bottom opening covered by a paper filter, and the bottom wall includes a centered larger opening located directly below the smaller opening. A first and a second seal strip are thermally bonded to openably close a top opening of the ground coffee bag to seal an amount of ground coffee therein. A user can dispose the coffee dripper on a cup and pour hot water into the ground coffee bag to make drip-brewed coffee, and the produced liquid coffee flows through the smaller and the larger opening down into the cup.

### FIELD OF THE INVENTION

The present invention relates to a paper-made coffee dripper for use in drip-brewing coffee, and more particularly to a paper-made coffee dripper that can be extended from a folded state into an upright standing state for disposing on a top of a container and includes a funnel-shaped ground coffee bag, allowing a user to manually make drip-brewed coffee with it.

### BACKGROUND OF THE INVENTION

A lot of people living in the busy and stressed modern society like to drink coffee because caffeine contained in coffee can stimulate the central nervous system, particular the brain cells, making people more alert and giving them a boost of energy to get rid of tiredness and resume work. Caffeine also has the effects of increasing human body's basic metabolism, anti-aging, promoting diuresis, stimulating gastrointestinal mobility and relieving constipation. These positive effects of caffeine on human body further attract people to drink coffee. Now, drinking coffee has become a vogue among people living in the modern society today.

In a specialty coffee shop, an experienced barista will first grind coffee beans into ground coffee and then make a cup of coffee beverage by decoction, infusion, drip brewing or some other methods. Some people like to add non-diary creamer, fresh milk or sugar to coffee. Therefore, different brands of 3-in-1 instant coffee sachets, each of which contains adequate amount of espresso powder, condensed creamer powder and powdered sugar, are very popular in the market. When pouring hot water onto the 3-in-1 instant coffee, the espresso powder, condensed creamer powder and powdered sugar are dissolved in water at the same time to make a cup of coffee. Therefore, the 3-in-1 instant coffee is a type of brewed coffee.

Most of the coffee lovers do not necessarily have good sense of taste, but they usually have a much deeper knowledge of coffee than others. To coffee lovers, coffee made from the sacheted 3-in-1 instant coffee cannot be said to be good coffee, and manually drip-brewing coffee is a basic condition to make good coffee. Presently, a type of drip-brewing coffee bag 70 having two hooking ears 72 provided on two opposite lateral sides thereof, as shown in FIG. 1, is available in the market. The drip-brewing coffee bag 70 has an amount of ground coffee 71 received therein. To use the drip-brewing coffee bag 70 for making drip-brewed coffee, simply hang the two hooking ears 71 on a rim of a container 73, and then pour hot water into the coffee bag 70. Thereafter, the produced liquid coffee 74 automatically flows out of the coffee bag 70 down into the container 73. In this case, the container 73 should have an adequate depth, such that the coffee bag 70 is not soaked in the liquid coffee 74 in the container 73. Otherwise, a smell of the paper material forming the coffee bag 70 would adversely affect the taste of the produced liquid coffee 74.

### SUMMARY OF THE INVENTION

A primary object of the present invention is to provide a paper-made coffee dripper for use in drip-brewing coffee. With the paper-made coffee dripper, a coffee lover can make delicious and pure drip-brewed coffee at any time and place.

Another object of the present invention is to provide a paper-made coffee dripper for use in drip-brewing coffee, which, after being used, can still release delicate coffee aroma and can therefore be placed indoor for the released coffee aroma to spread through the room.

To achieve the above and other objects, the paper-made coffee dripper according to the present invention is formed by folding a single sheet of heat-resistant, double-sided coated paper model, and includes a ground coffee bag, a front wall, a rear wall, a bottom wall, a first seal strip and a second seal strip. The front wall, the rear wall and the bottom wall are sequentially connected to one another and folded into a U-shaped stand. The ground coffee bag has an upper front end and an upper rear end glue-bonded to an upper end of the front wall and an upper end of the rear wall, respectively, such that the ground coffee bag is supported by the front and the rear wall to suspend in a space defined between the front and the rear wall. The coffee dripper can be disposed on a top of a cup for use.

The ground coffee bag is in the form of a square funnel and internally defines a space for holding an amount of ground coffee therein. The ground coffee bag includes at least one smaller opening centered at a bottom thereof and a water-permeable paper filter fixedly attached to the bottom thereof to cover the smaller opening.

The bottom wall defines a horizontal plane and has a larger opening formed at a center thereof. The larger opening is located directly below the smaller opening of the ground coffee bag, so that produced liquid coffee flowed through the smaller opening will also flow through the larger opening into the cup disposed below the coffee dripper.

The first seal strip is simultaneously connected to and located higher than the upper end of the front wall and the upper front end of the ground coffee bag; and the second seal strip is simultaneously connected to and located higher than the upper end of the rear wall and the upper rear end of the ground coffee bag. When the first and the second seal strip are thermally bonded to each other, a top opening of the ground coffee bag is closed. On the other hand, when the thermally bonded first and second seal strips are torn off, the closed top opening of the ground coffee bag can be opened again.

Since the ground coffee bag is formed by folding along a plurality of specific fold lines on a rectangular area of the single sheet of paper model, the ground coffee bag and accordingly the whole coffee dripper are extendable for use or collapsible for packaging and storage.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a sectional view showing a conventional drip-brewing coffee bag in use;

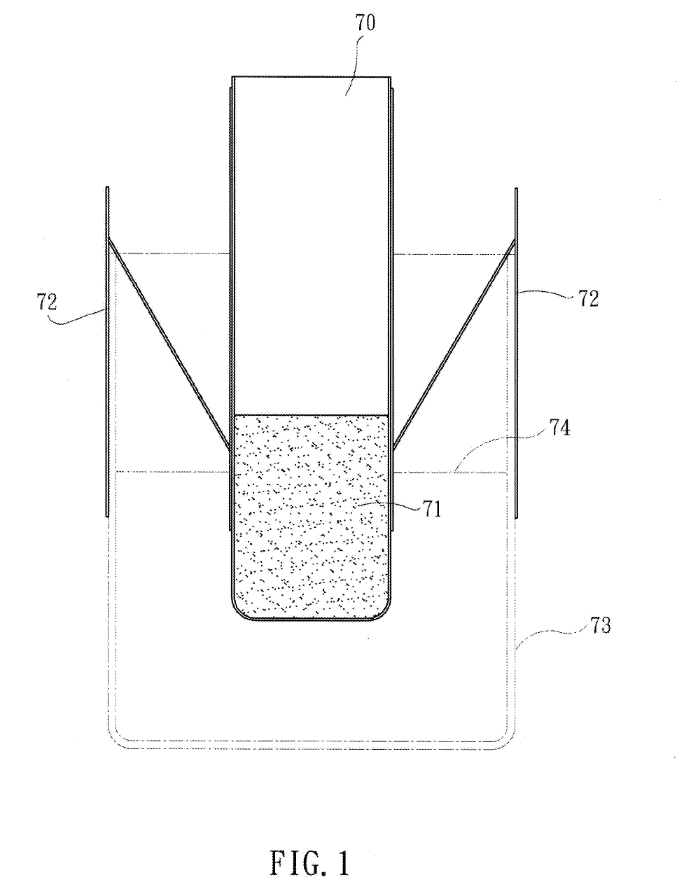

FIG. 2 is a perspective view of a paper-made coffee dripper for use in drip-brewing coffee according to an embodiment of the present invention;

FIG. 3 is a developed view of the paper-made coffee dripper of FIG. 2;

FIG. 4 is a cutaway view of the paper-made coffee dripper of FIG. 2 with a front wall and a first seal strip removed therefrom;

FIG. 5 is a side sectional view of the paper-made coffee dripper of FIG. 2 in an extended state;

FIG. 6 is a side sectional view of the paper-made coffee dripper of FIG. 2 in a folded state; and

FIG. 7 shows the paper-made coffee dripper of the present invention is disposed on a cup for use.

### DETAILED DESCRIPTION OF THE PREFERRED EMBODIMENTS

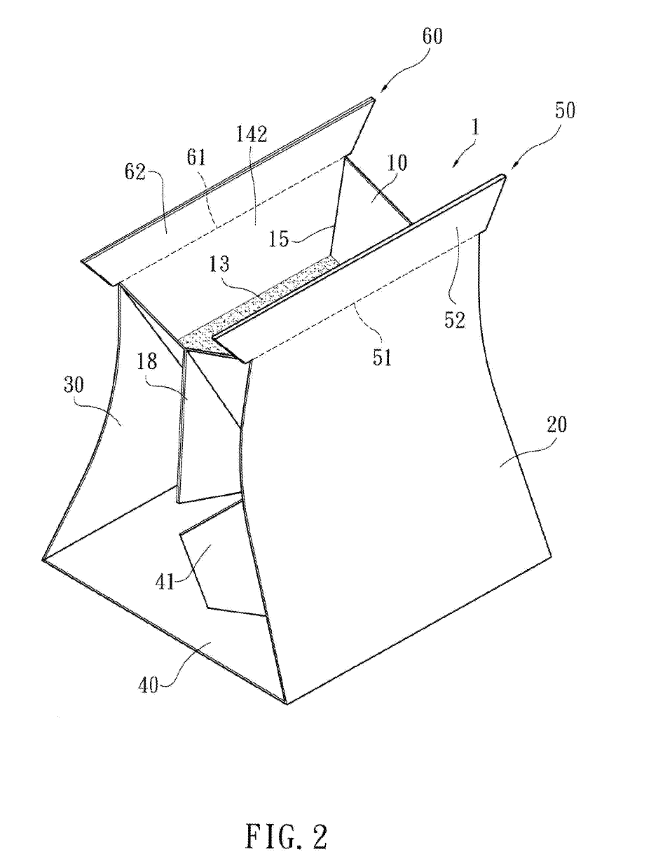

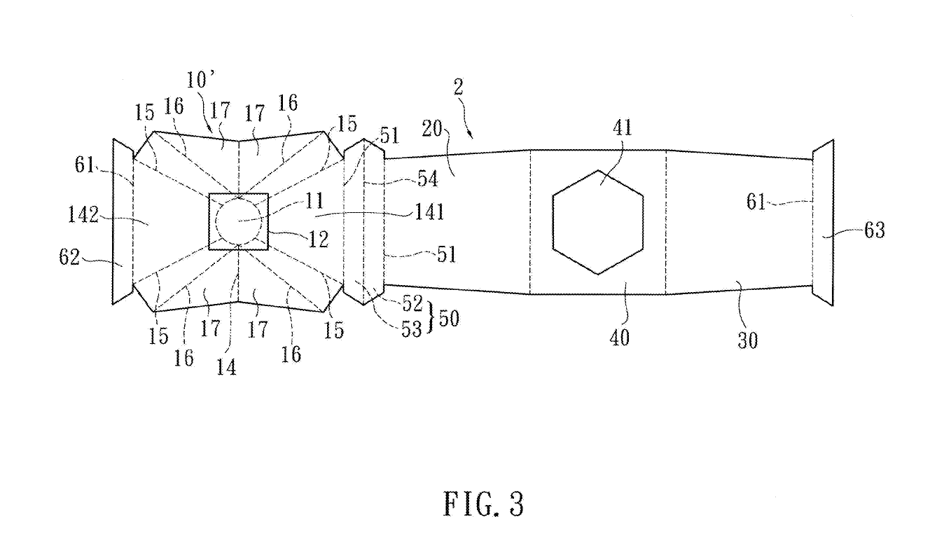

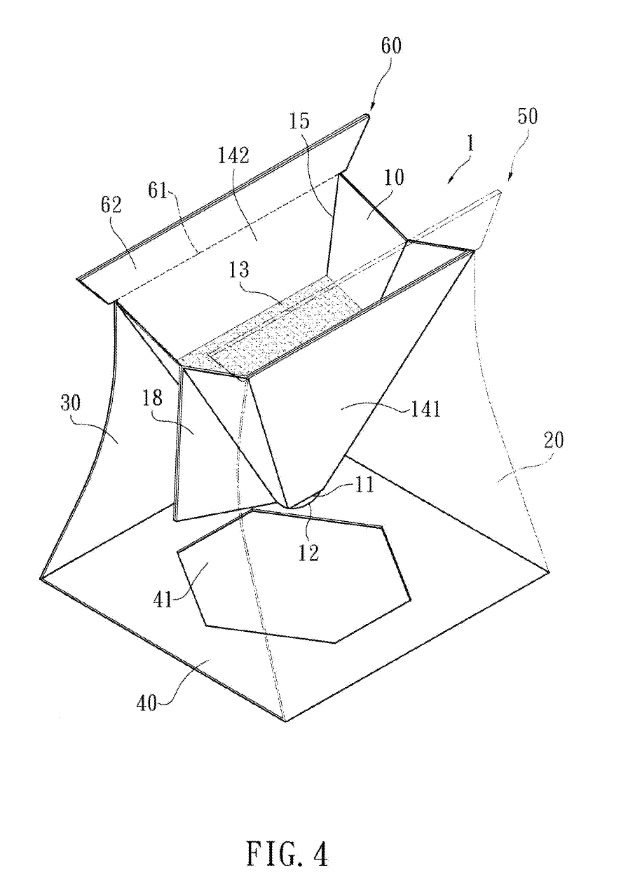

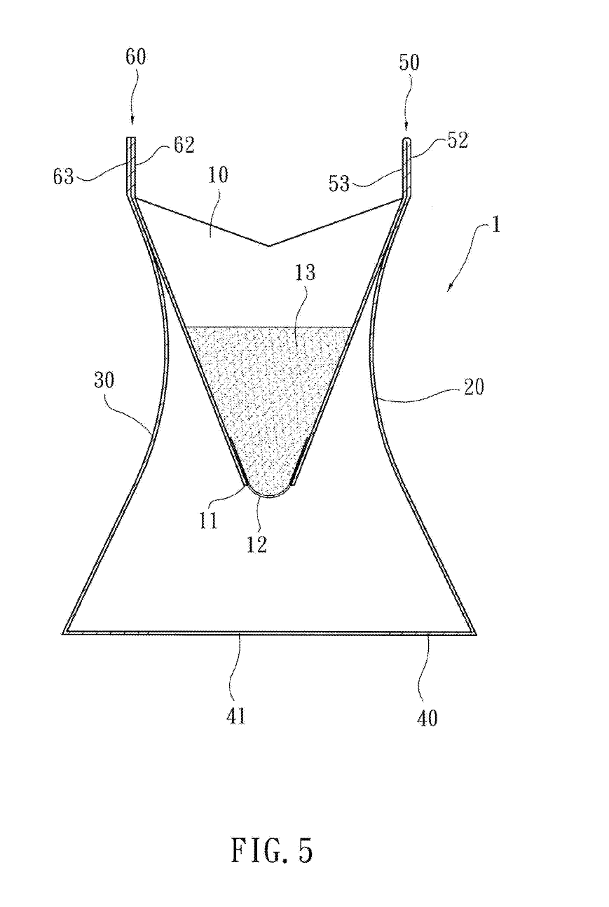

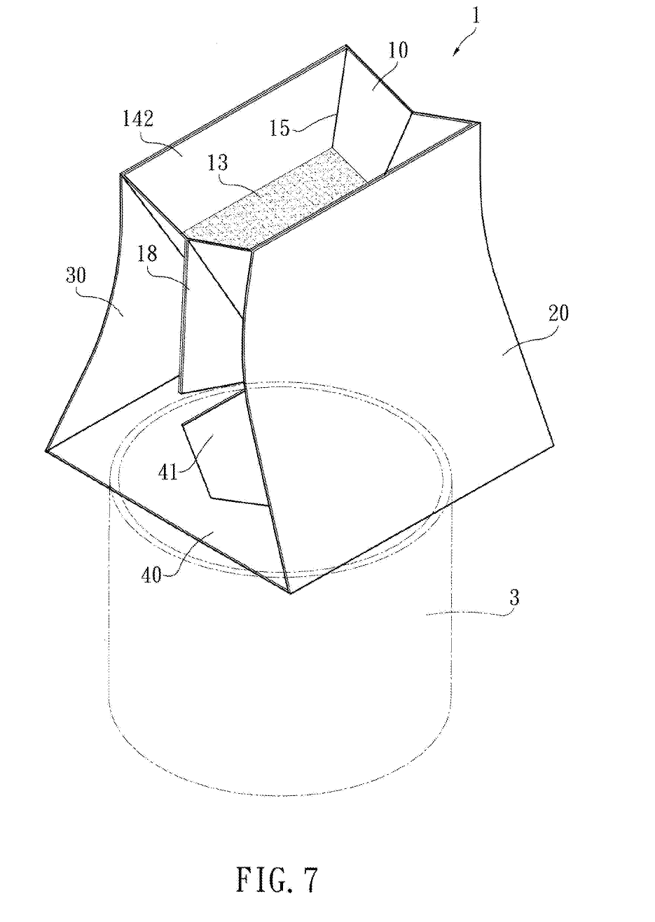

Please refer to FIGS. 2 to 4, in which a paper-made coffee dripper for use in drip-brewing coffee according to an embodiment of the present invention is shown. For the purpose of clarity and conciseness, the paper-made coffee dripper for use in drip-brewing coffee according to the present invention is also briefly referred to as the coffee dripper and generally denoted by reference numeral 1 herein. As shown, the coffee dripper 1 is formed by folding a single sheet of heat-resistant paper model 2. In the illustrated embodiment, the paper model 2 is made of double-sided coated paper. The coffee dripper 1 includes a ground coffee bag 10, a front wall 20, a rear wall 30, a bottom wall 40, a first seal strip 50 and a second seal strip 60. The front wall 20, the rear wall 30 and the bottom wall 40 are sequentially connected to one another and folded into a U-shaped stand. The ground coffee bag 10 has an upper front end and an upper rear end glue-bonded to an upper end of the front wall 20 and an upper end of the rear wall 30, respectively, such that the ground coffee bag 10 is supported by the front and the rear wall 20, 30 to suspend in a space defined between the front and the rear wall 20, 30. The bottom wall 40 defines a horizontal plane. When the coffee dripper 1 is in an extended state as shown in FIG. 5, a length of the bottom wall 40 between a front end and a rear end thereof is larger than a front-to-rear distance of the ground coffee bag 10, so that the whole coffee dripper 1 has a downward expanded configuration and accordingly a stable center of gravity without the risk of easily tilting over. The coffee dripper 1 can be disposed on a top of a cup 3 for use, as shown in FIG. 7.

The ground coffee bag 10 is provided at a bottom with at least one smaller opening 11, and a water-permeable paper filter 12 fixedly attached to the bottom of the ground coffee bag 10 to cover the smaller opening 11. Please refer to FIG. 5. The ground coffee bag 10 has an amount of ground coffee 13 held therein. While the paper filter 12 prevents the ground coffee 13 from falling out of the ground coffee bag 10 via the smaller opening 11, it allows produced liquid coffee to permeate therethrough into the cup 3. To use the coffee dripper 1, first dispose it on the top of the cup 3, as shown in FIG. 7. Then, slowly pour an amount of hot water of 80-90° C. into the ground coffee bag 10 to produce liquid coffee. The liquid coffee flows down into the cup 3 via the smaller opening 11 on the ground coffee bag 10 and another larger opening 41 formed on the bottom wall 40.

An area on the paper model 2 for correspondingly forming the substantially funnel-shaped ground coffee bag 10 is a rectangular area 10′. To form the ground coffee bag 10, first inward fold the rectangular area 10′ along a central fold line 14 to thereby form two identical parts, namely, a front part 141 and a rear part 142. Each of the front part 141 and the rear part 142 includes two laterally symmetrically arranged first fold lines 15 and two laterally symmetrically arranged second fold lines 16. Each of the first and second fold lines 15, 16 is extended from an edge of the rectangular area 10′ to an edge of the smaller opening 11. On each of the front and the rear part 141, 142, the first fold lines 15 are located at an inner side of the second fold lines 16. For forming the ground coffee bag 10, the front and the rear part 141, 142 are respectively inward folded along the two first fold lines 15 and outward folded along the two second fold lines 16. An area between each of the second fold lines 16 and the central fold line 14 is defined as a bonding surface 17. When the bonding surfaces 17 on the front part 141 are correspondingly bonded to the bonding surfaces 17 on the rear part 142 by way of thermal bonding, an integral square funnel is formed. Meanwhile, the bonding surfaces 17 on the front part 141 and the rear part 142, after being correspondingly bonded together, form a left and a right wing portion 18 at two opposite lateral sides of the ground coffee bag 10, as can be seen in FIGS. 2, 4 and 7.

Please also refer to FIG. 5. The front wall 20 is located in front of the ground coffee bag 10 with its upper end glue-bonded to the upper front end of the ground coffee bag 10 and forming a support thereto. It is noted the front wall 20 has a width that gradually increases from top to bottom.

The rear wall 30 is located behind the ground coffee bag 10 with its upper end glue-bonded to the upper rear end of the ground coffee bag 10 and forming a support thereto. It is also noted the rear wall 30 has a width that gradually increases from top to bottom.

The bottom wall 40 is connected at its front edge to a lower end of the front wall 20 and at its rear edge to a lower end of the rear wall 30. The bottom wall 40 is in a horizontal state with the larger opening 41 formed at a center thereof. The larger opening 41 is located directly below the smaller opening 11 of the ground coffee bag 10, so that the produced liquid coffee flowed through the smaller opening 11 will also flow through the larger opening 41.

As can be seen in FIG. 2, the first seal strip 50 is in the form of an elongated strip having an overall length larger than a width of a top opening of the ground coffee bag 10. The first seal strip 50 is simultaneously connected to and located higher than the upper end of the front wall 20 and the upper front end of the ground coffee bag 10. The second seal strip 60 is also in the form of an elongated strip having an overall length larger than the width of the ground coffee bag 10. The second seal strip 60 is simultaneously connected to and located higher than the upper end of the rear wall 20 and the upper rear end of the ground coffee bag 10. The first and the second seal strip 50, 60 are thermally bonded to each other to close the top opening of the ground coffee bag 10, so that the ground coffee 13 is sealed in the ground coffee bag 10. On the other hand, the thermally bonded first and second seal strips 50, 60 can be torn off to present the top opening of the ground coffee bag 10 again, as can be seen in FIG. 7. The coffee dripper 1 can be disposed on a cup 3 for making hand-drip coffee. To enable convenient tearing off of the first seal strip 50, a tear line 51 is provided at a joint of the front wall 20 and the ground coffee bag 10. Similarly, to enable convenient tearing off of the second seal strip 60, a tear line 61 is provided at a joint of the rear wall 30 and the ground coffee bag 10.

Another area on the paper model 2 for correspondingly forming the first seal strip 50 includes a first elongated strip 52, which is located adjacent to the front wall 20, and a second elongated strip 53, which is located behind the first elongated strip 52 and adjacent to the front part 141. When the coffee dripper 1 is formed, the first elongated strip 52 has a front edge connected to the upper end of the front wall 20 and a rear edge connected to a front edge of the second elongated strip 53. The second elongated strip 53 has a rear edge connected to the ground coffee bag 10. The first and the second elongated strip 52, 53 are outward folded toward each other along a joint line between them and are then thermally bonded together, so as to form the first seal strip 50 that is located higher than the ground coffee bag 10.

Another two areas on the paper model 2 for correspondingly forming the second seal strip 60 include a third elongated strip 62 and a fourth elongated strip 63. The third elongated strip 62 has a front edge connected to the upper rear end of the ground coffee bag 10 and the fourth elongated strip 63 is connected to the upper end of the rear wall 30. The third and the fourth elongated strip 62, 63 are thermally bonded together, so as to form the second seal strip 60 that is located higher than the ground coffee bag 10. Meanwhile, when the third and the fourth elongated strip 62, 63 are bonded into an integral body to form the second seal strip 60, the coffee dripper 1 is almost completed and can stand upright.

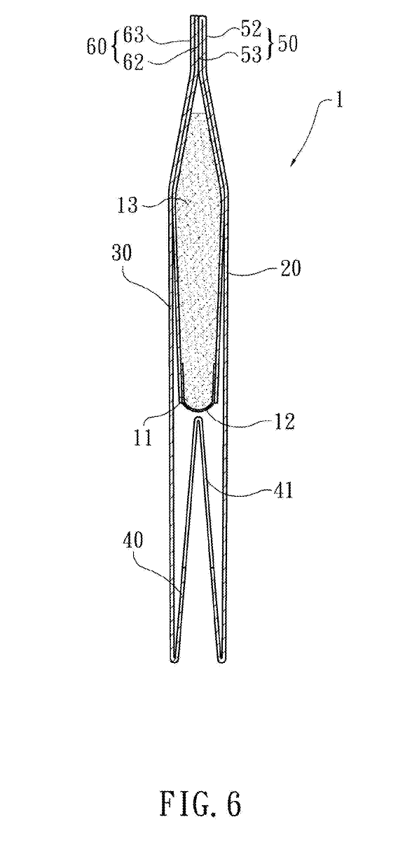

The first seal strip 50 and the second seal strip 60 of the coffee dripper 1 can be glue-bonded together to close the top opening of the ground coffee bag 10 and seal the ground coffee 13 in the ground coffee bag 10. At this point, the coffee dripper 1 is fully completed and can be folded and pressed from front and rear sides into a substantially flat state, as shown in FIG. 6, so that the flattened coffee dripper 1 can be packed in a sealed plastic packaging bag (not shown) for selling. To use the coffee dripper 1, simply tear open the packaging bag to remove the coffee dripper 1 therefrom, and tear off the first and the second seal strip 50, 60 to present the top opening of the ground coffee bag 10.

When using the coffee dripper 1 to make hand-drip coffee, the ground coffee bag 10 is located above the cup 3 without being soaked in the liquid coffee contained in the cup 3, so that the produced liquid coffee is pure. When the ground coffee 13 in the ground coffee bag 10 has been drip-brewed once, the coffee dripper 1 can be removed from the cup 3 and disposed in a dish (not shown), and a user may conveniently drink the produced coffee. The ground coffee 13 in the coffee dripper 1 can be drip-brewed for a second time to make another cup of hand-drip coffee. When the used ground coffee 13 is completely air dried, the used coffee dripper 1 can be directly placed on a tabletop, and the aroma constantly released from the used ground coffee in the coffee dripper 1 is a natural freshener to a coffee lover.

The front and the rear wall 20, 30 of the coffee dripper 1 can be printed with pictures of some historical stories, beautiful scenes, historical persons and the like, which can also become interesting topics for chatting with friends while drinking coffee.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A paper-made coffee dripper for use in drip-brewing coffee, being formed by folding a single sheet of heat-resistant paper model made of a food-grade double-sided coated paper; the coffee dripper comprising:
a ground coffee bag being formed by folding an area of the paper model and in the shape of a square funnel for holding an amount of ground coffee therein; and the ground coffee bag including at least one smaller opening centered at a bottom thereof and a water-permeable paper filter fixedly attached to the bottom thereof to cover the smaller opening;
a front wall being located in front of the ground coffee bag and having an upper end glue-bonded to an upper front end of the ground coffee bag to form a support thereto; and the front wall having a width that gradually increases from top to bottom;
a rear wall being located behind the ground coffee bag with an upper end glue-bonded to an upper rear end of the ground coffee bag to form a support thereto; and the rear wall having a width that gradually increases from top to bottom;
a bottom wall being connected at a front edge to a lower end of the front wall and at a rear edge to a lower end of the rear wall; the bottom wall and the front and the rear wall together forming a U-shaped stand, such that the ground coffee bag is supported by the front and the rear wall to suspend in a space defined between the front and the rear wall; the bottom wall including a centered larger opening located directly below the smaller opening of the ground coffee bag; and a length of the bottom wall between the front edge and the rear edge thereof being larger than a front-to-rear distance of the ground coffee bag;
a first seal strip being in the form of an elongated strip having an overall length larger than a width of a top opening of the ground coffee bag; and the first seal strip being simultaneously connected to and located higher than the upper end of the front wall and the upper front end of the ground coffee bag; and
a second seal strip being in the form of an elongated strip having an overall length larger than the width of the top opening of the ground coffee bag; and the second seal strip being simultaneously connected to and located higher than the upper end of the rear wall and the upper rear end of the ground coffee bag; and
the first and the second seal strip being thermally bonded to each other to close the top opening of the ground coffee bag; and the mutually bonded first and second seal strips being removable by tearing them off to present the top opening of the ground coffee bag again.

2. The paper-made coffee dripper as claimed in claim 1, wherein the area on the paper model for correspondingly forming the ground coffee bag is a rectangular area, which is inward folded along a central fold line to thereby form two identical parts, namely, a front part and a rear part; each of the front and the rear part including two laterally symmetrically arranged first fold lines and two laterally symmetrically arranged second fold lines; each of the first and second fold lines being extended from an edge of the rectangular area to an edge of the smaller opening; on each of the front and the rear part, the first fold lines being located at an inner side of the second fold lines; the front part and the rear part being respectively inward folded along the two first fold lines and outward folded along the two second fold lines; an area between each of the second fold lines and the central fold line forming a bonding surface; and the bonding surfaces on the front part being correspondingly bonded to the bonding surfaces on the rear part by way of thermal bonding to complete the forming of the square funnel-shaped ground coffee bag.

3. The paper-made coffee dripper as claimed in claim 2, wherein the bonding surfaces on the front part and the bonding surfaces on the rear part, after being correspondingly bonded together, form a left and a right wing portion at two opposite lateral sides of the ground coffee bag.

4. The paper-made coffee dripper as claimed in claim 1, wherein the first seal strip includes a first elongated strip, which is located adjacent to the front wall; and a second elongated strip, which is located behind the first elongated strip; the first elongated strip having a front edge connected to the upper end of the front wall and a rear edge connected to a front edge of the second elongated strip, and the second elongated strip having a rear edge connected to the ground coffee bag; and the first and the second elongated strip being outward folded toward each other along a joint line between them and then being thermally bonded together to form the first seal strip that is located higher than the ground coffee bag.

5. The paper-made coffee dripper as claimed in claim 4, wherein the second seal strip includes a third elongated strip and a fourth elongated strip; the third elongated strip having a front edge connected to the upper rear end of the ground coffee bag and the fourth elongated strip being connected to the upper end of the rear wall; and the third and the fourth elongated strip being thermally bonded together to form the second seal strip that is located higher than the ground coffee bag.
